(19) United States
(12) Patent Application Publication
(10) Pub. No.: US 2019/0199689 A1
(43) Pub. Date: Jun. 27, 2019

(54) SECURING DATA OBJECTS THROUGH BLOCKCHAIN COMPUTER PROGRAMS

(71) Applicant: SAP SE, Walldorf (DE)

(72) Inventors: Brian McKellar, Walldorf (DE); Steffen Knoeller, Walldorf (DE)

(21) Appl. No.: 15/849,760

(22) Filed: Dec. 21, 2017

(51) Int. Cl. H04L 29/06; H04L 9/08

(52) U.S. Cl. CPC H04L 63/0428; H04L 9/0819; H04L 63/061

(57) ABSTRACT

A computer program is initialized within a distributed network. The computer program includes one or more conditions for accessing data associated with the computer program. One or more values for initializing one or more parameters within the one or more conditions are loaded. The one or more parameters are initialized based on data in a number of data blocks of the blockchain. The number of data blocks is stored at a number of computer systems connected to the distributed network. A request associated with providing a data object to the distributed network is received. Based on evaluation of the request, the data object is stored at the computer program. A second request to retrieve the data object is rejected by the computer program when a retrieving condition of the one or more conditions is not fulfilled.

### BACKGROUND

Documents or other data objects that include sensitive information are often encrypted to prevent unauthorized access to the information. There are scenarios where multiple entities create and submit data objects to a requesting entity. In such cases, the data objects may include information that is shared and known to a creating entity and the requesting entity, and is not accessible to other entities sharing data with the requesting entity. For example, a data object may be shared between a service provider and a client. Sensitivity of information may be associated with time of possessing the information. For example, a portion of information may be classified as sensitive for a certain period of time before a decision is made based on the portion of information or until an action is executed based on the portion of information. Typically, protection of sensitive information is provided by agreements between the creating entity and the requesting entity. These agreements define rules and periods for sharing (or not sharing) the sensitive information and do not directly safeguard the data objects.

Utilizing distributed database records such as blockchains for submission of the data objects enables protection of the data objects upon submission. The creating entity may initially write a hash value of the data object to a distributed database record instead of writing the data object. The hash value may be calculated based on the sensitive information to be provided to the requesting entity. The hash value may be combined with metadata such as a timestamp to verify that the creating entity complies with a requirement defined by the requesting entity (e.g., a deadline).

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 is a block diagram illustrating a distributed network to store data objects, according to one embodiment.

FIG. 2 is a flow diagram illustrating a process to store data objects, according to one embodiment.

FIG. 3 is a block diagram illustrating a system to securely store data objects in a distributed database record, according to one embodiment.

FIGS. 4A-4B are flow diagrams illustrating a process to securely store data objects in a distributed database record, according to one embodiment.

FIG. 5 is a block diagram of an exemplary computer system, according to one embodiment.

### DETAILED DESCRIPTION

Embodiments of techniques for securing data objects through blockchain computer programs are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

Submitting hash values of data objects instead of the data objects ensures that versions of information within the data objects were finalized at the time of submission. At the same time, fraud possibilities are eliminated because the information within the data objects is not submitted. Hash values are generated by hashing algorithms based on input data. A hash value corresponds to a specific combination of symbols that represents the input data. The hash value is a logical function of the combination of symbols. When a hash value is computed based on information within a data object, the hash value represents a logical function of the combination of symbols that represents the information. The hash value uniquely corresponds to the information within the data object. The hash value represents a specific signature of the combination of symbols in the data object. The hash value uniquely identifies the data object among a number of data objects exchanged between creating entities and the requesting entity. Hash values may be computed in accordance with a number of hashing functions/algorithms that include, but are not limited to, “message digest” 5 (MD5) hashing function/algorithm, Secure Hash Algorithm 1 (SHA-1), Secure Hash Algorithm 2 (SHA-2), “Fowler-Noll-Vo (FNV) hash” function, “Jenkins hash” function, “Pearson hashing” function, and “Zobrist hashing” function.

When a requesting entity initiates review of the data objects, the creating entities provide the data objects including the sensitive information to the requesting entity. Sensitive information within a data object of a creating entity may include technical proposals, description of activities, pricing or other information related to offers for acquisition of equipment, materials, supplies, or services. The requesting entity may re-calculate a hash value of a data object to verify authenticity of the information within the data object. However, leakage of sensitive information to a third party through various channels, both from the creating entity and from the requesting entity, remains possible. For example, sensitive information of a first creating entity may be acquired by a second creating entity thus affecting fair competitiveness. Based on the sensitive information of the first creating entity, the second creating entity may decide to not deliver the data object matching the computed hash value that has been stored beforehand in the distributed database record, either due to technology relevant issues, or due to other reasons. Storing data objects securely to ensure both protection and availability of the sensitive information is challenging and effort-consuming.

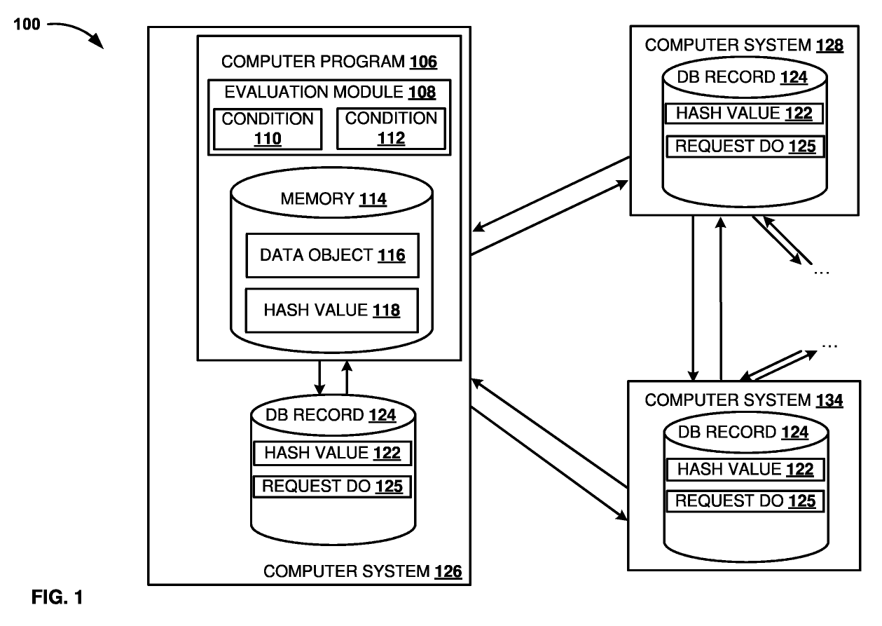

FIG. 1 illustrates distributed network 100 to store data objects, according to one embodiment. The distributed network 100 is a network that includes a number of interconnected computer systems. The computer systems in the distributed network 100 store database (DB) record 124. The DB record 124 includes data written by computer systems 126, 128, and 134 and metadata for the data. For example, the DB record 124 may store tracing and logging information for transactions executed over the stored data. In addition, the DB record 124 may include a record of transactions executed by the computer systems (e.g., computer systems 126, 128, and 134) within the distributed network 100. The computer systems within the distributed network 100 maintain local copies of the DB record 124.

In one embodiment, data object 116 represents a unit of data. The data object 116 may correspond to one or more computer files. The one or more computer files may include sensitive information. The data object 116 is received at running computer program 106. In one embodiment, the computer program 106 is a dedicated computer program for storing data objects securely. The computer program 106 receives data objects, stores the data objects, and reads the data objects upon request. For example, the computer program 106 may receive a data object that includes sensitive information associated with pricing of a technical proposal for acquisition of equipment. The data object may be stored by the computer program 106. The computer program 106 may read the data object when a read request is received. The computer program 106 is configured to store a data object received before a deadline and read the data object upon expiration of the deadline. By allowing storage of data objects before a deadline and reading the data objects upon expiration of the deadline, the computer program 106 eliminates fraud possibilities and ensures data objects' availability at a later stage. The computer program 106 may be configured to store the data objects in a volatile memory associated with the computer program 106. The data objects stored by the computer program 106 are not accessible to other computer programs or users.

In one embodiment, the computer program 106 runs on computer system 126. The computer system 126 may be a personal computer, a server, a mobile device or another computing device that is capable of storing and executing computer readable instructions. The computer system 126 is connected to the distributed network 100. The distributed network 100 includes a number of computer systems, e.g., similar to the computer system 126, such as computer system 128 and computer system 134.

When a transaction is executed over the associated DB record 124 at a computer system of the distributed network 100, the transaction is automatically replicated to the DB records 124 associated with the other computer systems in the network 100. In various embodiments, replication of the transaction may include replication of the DB record 124, a delta update of a portion of data affected by the transaction within the DB record 124, one or more records that the transaction occurred, or a combination of the above. For example, the computer systems 126, 128, and 134 may be referred to as nodes of a blockchain. A node of a blockchain is associated with a corresponding database storing a copy of a distributed database record (e.g., the DB record 124) associated with the blockchain. Computer programs (i.e., smart contracts) such as the computer program 106 may run on one or more of the blockchain nodes, may execute transactions over local copies of the distributed database record, and may write data blocks including data associated with the transactions to corresponding one or more databases associated with the one or more blockchain nodes. The distributed database record may be stored within the data blocks in the databases. The data blocks associated with the transactions may be automatically replicated across the blockchain nodes.

In one embodiment, the computer program 106 receives a request to store data object 116. The computer program 106 is configured to store the data object 116 when condition 110 is fulfilled. The computer program 106 may include the condition 110 and condition 112. The conditions 110 and 112 may be defined by a requesting entity (not illustrated). For example, the requesting entity may develop the computer program 106 and define the conditions 110 and 112 in the computer program 106. Alternatively, the computer program 106 may be configured by a third party to load requests for data objects and automatically configure the conditions 110 and 112 based on requirements included in the requests for data objects.

In one embodiment, the requesting entity may submit a request for data objects. The request for data objects may include one or more requirements and/or conditions. For example, the request may include description of technical requirements for equipment and a deadline for submission of the data objects. For example, the request may be submitted to the distributed network 100. In such a case, the request including the requirements and conditions may be stored in DB record 124 associated with a computer system in the distributed network 100 as request for data objects (“request DO”) 125. Consequentially, the “request DO” 125 may be automatically replicated across computer systems of the distributed network 100, including the DB record 124 associated with the computer system 126.

In one embodiment, the computer program 106 is configured to receive data objects based on data in the DB record 124. For example, the DB record 124 may include the “request DO” 125. The computer program 126 loads the requirements and conditions of the “request DO” 125 from the DB record 124. Upon loading, the computer program 106 is configured to accept data objects based on one or more conditions. It should be appreciated that the requirements and conditions of the “request DO” 125 may be loaded in the computer program 106 from various memories and storage devices, either internal or external to the distributed network 100, that are different from the DB record 124. The computer program 106 may be also configured to receive the data objects by an administrator (not illustrated) of the computer system 126.

In one embodiment, the computer program 106 includes evaluation module 108. The evaluation module 108 evaluates requests to the computer program 106. When a “write” request is received at the computer program 106, the evaluation module 108 checks whether condition 110 is fulfilled. In one embodiment, condition 110 may be a storing condition. The condition 110 (and the condition 112) may be pre-configured in the computer program 106. For example, the condition 110 may require a current date to be before or to match with a target date (e.g., deadline date). An exemplary definition of the storing condition 110 may read: “if current date is before or equals [target date], store data object; else return error message”. The target date may be configured as a parameter (not illustrated) of the computer program 106. Within the current example, the evaluation module 108 may compare the current date with the target date as defined at the conditions 110 and 112. When the current date is before the target date, the evaluation module 108 determines that the condition 110 is fulfilled. The target date is defined by a value of the parameter.

Condition 112 may be a reading condition and may require the current date to equal or be after the target date. An exemplary definition of the condition 112 may read: “if current date is after [deadline date], read data object, else return error message”.

In one embodiment, the computer program 106 automatically configures the target date based on a value of the parameter. The value of the parameter is loaded from the “request DO” 125 in the DB record 124. The parameter may be a variable of the computer program 106. The parameter may be associated with one or more functions of the computer program 106. The parameter may refer to a portion of data provided as input to the functions of the computer program 106. The value of the parameter may represent the portion of data that is provided as input (e.g., the target date that is set by the requesting entity). The computer program 106 requires a value input for the parameter when initialized. The computer program 106 may not operate when input data such as a parameter value is not available.

The computer program 106 may include one or more parameters that refer to one or more functions of the computer program 106. The one or more parameters may be initialized in relation with the one or more conditions. For example, the computer program 106 may include a “write” function and a “read” function (not illustrated). The functions of the computer program 106 may require the value of the parameter as input data to operate. The value of the parameter may be defined by the requesting entity in the “request DO” 125. The value of the parameter may be part of the requirements and conditions of the “request DO” 125. The value of the parameter is loaded when the computer program 106 is initialized.

In one embodiment, the data object 116 is written to memory 114 when the condition 110 is fulfilled. The memory 114 may be part of a system memory (not illustrated) of the computer system 126. The memory 114 may be dynamically allocated by the computer program 106 when the computer program is initialized. The memory 114 is a volatile-type memory that stores data while the computer program 106 is running. The computer program 106 may store temporary data such as variables, classes, class instances, etc., in the memory 114. The memory 114 stores temporary data of the computer program 106 that is not persisted. The stored data is available to the computer program 106 and not accessible to other computer programs and/or users either within the distributed network 100 or outside the distributed network 100. Data in the memory 114 is available when the computer program 106 is running. The data in the memory 114 may be lost or erased when the operation of the computer program 106 is interrupted. The computer program 106 may run continuously when the computer system 126 is protected against power outage.

In one embodiment, the computer program 106 receives the request to store the data object 116 from a computer system within the distributed network 100. For example, the request may be received from the computer system 128. The computer system 128 may be associated with an application (not illustrated) that triggers submission of the data object 116 to the computer program 106, for example, upon receiving input from a user interface (UI) (not illustrated) of the application. Alternatively, the application may be configured to automatically submit one or more data objects to the computer program 106, e.g., on a predefined interval of time. The data objects may be fed to the application by one or more creating entities (not illustrated) that create data objects. One or more systems within the distributed network 100 may host applications that are configured to submit data objects to the computer program 106.

In one embodiment, the computer program 106 is configured to calculate hash value 118 based on the data object 116. The hash value 118 may be calculated in accordance with a hashing algorithm/function such as MD5 or other. The hash value 118 uniquely corresponds to the data object 116. The hash value 118 represents a specific signature and combination of symbols in the data object 116. Thus, when even a symbol of the data object 116 is amended, a different hash value is generated by the same algorithm.

In one embodiment, the computer program 106 receives a request to read the data object 116. For example, the request may be sent from the computer system 134 or from another computer system within the distributed network 100. The computer system 134 may be associated with an application (not illustrated) that triggers reading of the data object 116 from the computer program 106, for example, upon receiving input from a user interface (UI) (not illustrated) of the application. Alternatively, the application may be configured to automatically read one or more data objects from the computer program 106, e.g., upon expiration of a deadline. The data objects may be extracted from the memory 114 by the computer program 106 and provided to the application. One or more systems within the distributed network 100 may host applications that are configured to read data objects from the computer program 106.

In one embodiment, the computer program 106 includes a “read” function. When a request to invoke the “read” function of the computer program 106 is received, the evaluation module 108 evaluates the request to determine whether the condition 112 is fulfilled. For example, when the condition 112 is “if current date is after [target date], read data object, else return error message”, the evaluation module 108 compares a current date with the target date to determine whether the condition 112 is fulfilled. The condition 112 is fulfilled when the current date is after the target date. When the evaluation module 108 determines that the condition 112 is not fulfilled, the computer program 106 rejects the request.

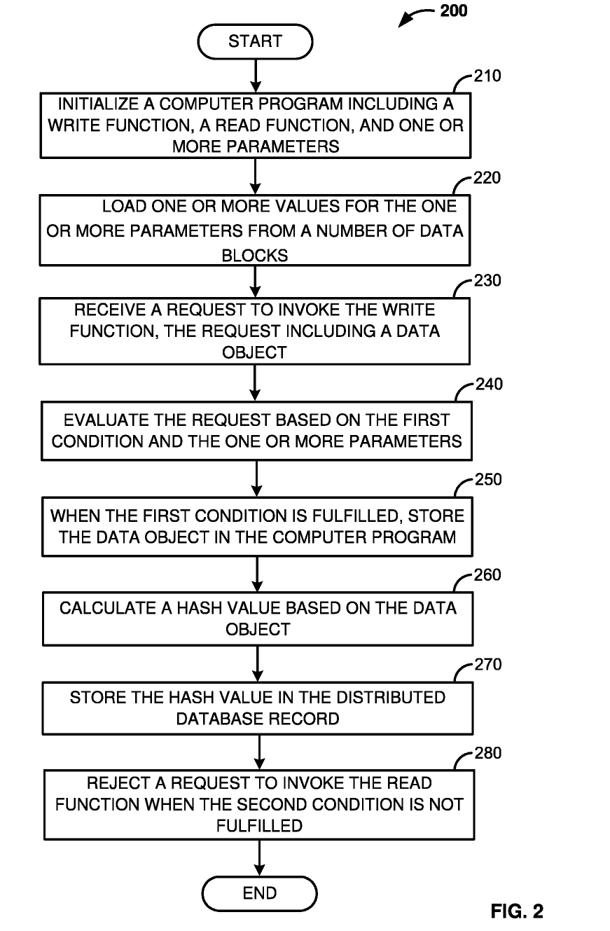

FIG. 2 illustrates process 200 to store a data object, according to one embodiment. At 210, a computer program is initialized. For example, the computer program 106, FIG. 1, may be initialized. The computer program is a dedicated computer program for storing data objects securely within a distributed network. The computer program receives data objects, stores the data objects, and reads the data objects upon request. For example, the computer program receives data objects that include sensitive information associated with pricing of a technical proposals for acquisition of equipment, materials, or services. The data objects are stored within the computer program. The computer program provides one or more functionalities via one or more functions.

In one embodiment, the computer program provides a “write” function and a “read” function. In addition, the computer program includes one or more parameters referred by the functions. The computer program evaluates incoming requests from computer systems connected to the distributed network. The computer program is configured to invoke the “write” function when a first condition is fulfilled and to invoke the “read” function when a second condition is fulfilled. The computer program is configured to store the data objects in a volatile memory associated with the computer program. The data objects stored by the computer program are not accessible to other computer programs or users. In one embodiment, the first and the second condition are based on the one or more parameters.

At 220, one or more values for the one or more parameters of the computer program are loaded from a number of data blocks. The number of data blocks may store a distributed database record. For example, the DB record 124, FIG. 1 may be stored at the number of data blocks. The first and the second condition are based on data at the number of data blocks. The distributed database record is associated with a number of distributed database records that store copies of transactions executed over the distributed database records. In one embodiment, a data block associated with a transaction executed over a distributed database record of the number of distributed database records is automatically replicated to the number of data blocks. The number of data blocks is stored in a number of databases that run on a number of computer systems connected in a distributed network.

At 230, a request to invoke the write function of the computer program is received. The request includes a data object. The data object may be stored by invoking the write function of the computer program. At 240, the request is evaluated based on the first condition and the values of the parameters. For example, the request may be evaluated by the evaluation module 108, FIG. 1. When the evaluation module determines that the first condition is fulfilled, at 250, the data object is stored in the computer program.

At 260, a hash value is calculated based on the data object. The hash value uniquely identifies information within the data object. At 270, the hash value is stored in the distributed database record. At 280, the request to invoke the “read” function is rejected when the second condition is not fulfilled. For example, the evaluation module evaluates the request to invoke the “read” function based on the second condition and the value of the parameter, and determines that the second condition is not fulfilled. Thus, the request to invoke the read function is rejected.

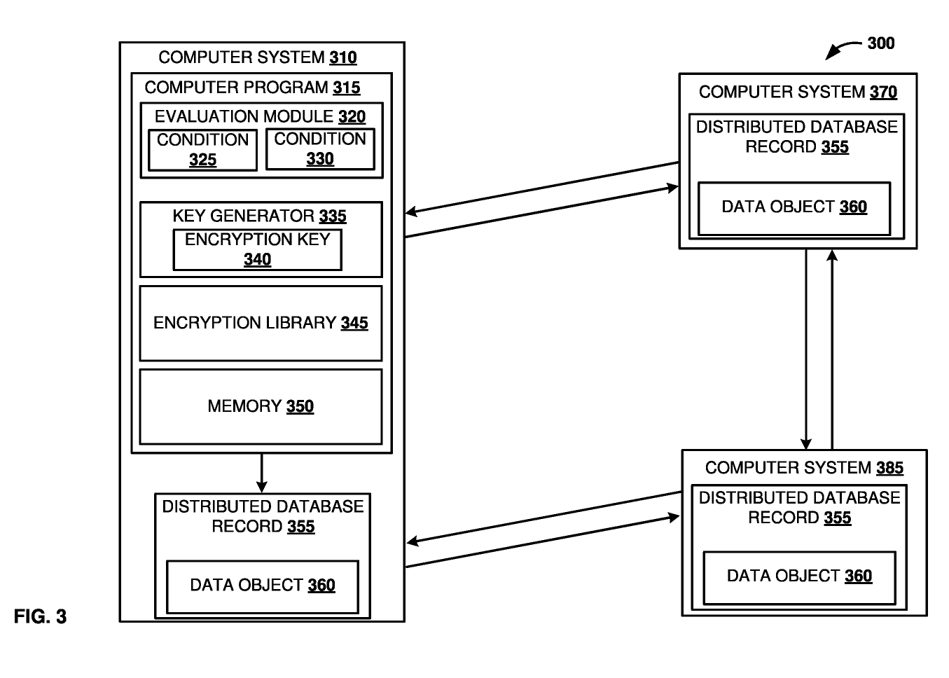

FIG. 3 illustrates system 300 to securely store data objects in a distributed database record, according to one embodiment. The system 300 includes computer program 315. The computer program 315 is similar to the computer program 106, FIG. 1. The computer program 315 provides one or more functionalities via one or more functions. For example, the computer program 315 provides a functionality to store data objects and a functionality to read data objects via a “write” function and a “read” function, respectively. In addition, the computer program 315 includes one or more parameters referred by the functions. The computer program 315 runs on computer system 310. The computer system 310 may be a personal computer, a server, a mobile device, or another computing device capable of storing and executing computer readable instructions.

In one embodiment, the computer system 310 is connected to a distributed network (not illustrated) that includes a number of systems such as the computer system 310, similar to computer system 370 and computer system 385. Computer systems in the distributed network store distributed database record 355. The distributed database record 355 includes data stored by the computer systems 310, 370, and 385, and metadata associated with the data. For example, the distributed database record 355 may be stored within a chain of transaction data blocks (not illustrated). A data block in the chain of transaction data blocks accumulates data and metadata for corresponding one or more transactions executed within a predefined period by the computer systems in the distributed network. The computer systems in the distributed network maintain local copies of the distributed database record 355. For example, the computer system 310, the computer system 370, and the computer system 385 store copies of the distributed database record 355. When a transaction is executed over the distributed database record 355 by the computer system 310, the transaction is automatically replicated to copies of the distributed database record 355 associated with the computer systems 370 and 385.

In one embodiment, the computer program 315 receives requests to write data objects and requests to read the data objects. The computer program 315 may receive the requests to write the data objects from the computer system 370. The computer system 370 may be associated with an application (not illustrated) configured to submit data objects to the computer program 315. The application may automatically submit one or more data objects to the computer program 315, e.g., on a predefined interval of time. The data objects may be fed to the application by one or more creating entities (not illustrated) that create data objects.

In one embodiment, the computer program 315 includes evaluation module 320. The evaluation module 320 is configured to evaluate requests received at the computer program 315. For example, the evaluation module 320 may evaluate requests based on predefined conditions. The evaluation module 320 includes condition 325 and condition 330. The evaluation module 320 evaluates requests to invoke the “write” function of the computer program 315 based on the condition 325 and a value of the parameter of the computer program 315, as described above with reference to the evaluation module 108, FIG. 1. In addition, the evaluation module 320 evaluates requests to invoke the “read” function of the computer program 315 based on the condition 330 and the value of the parameter.

In one embodiment, the computer program 315 is configured to invoke the “write” function when the condition 325 is fulfilled and to invoke the “read” function when the condition 330 is fulfilled. The computer program 315 stores data objects in memory 350 associated with the computer program 315. The data objects stored by the computer program 315 are not accessible to other computer programs or users. In one embodiment, the condition 325 and the condition 330 are based on the parameter of the computer program 315.

In one embodiment, the computer system 315 includes key generator 335. The key generator 335 generates encryption key 340 for a data object that is received and stored. For example, when the evaluation module 320 determines that the condition 325 is fulfilled, the “write” function of the computer program 315 may be invoked to store the data object. When the “write” function is invoked, the key generator 335 generates encryption key 340. The encryption key 340 is a randomly generated sequence of digits (e.g., a string) for scrambling or unscrambling data. Encryption keys are designed with algorithms that ensure that a key is unpredictable and unique. Based on the encryption key 340, data may be encrypted, decrypted, or encrypted and decrypted. When generated, the encryption key 340 is saved in memory 350 of the computer program 315. The memory 350 is similar to the memory 114, FIG. 1. The memory 350 is a volatile-type memory that stores data while the computer program 315 is running. The stored data is available to the computer program 315. The stored data is not accessible to other computer programs and/or users. Data in the memory 350 is stored while the computer program 315 is running and may be lost or erased when operation of the computer program 315 is interrupted.

In one embodiment, the encryption key 340 is provided to encryption library 345. The encryption library 345 is a collection of resources that may be consumed by the computer program 315. The resources include, among others, configuration data, pre-written code and subroutines, classes, values or type specifications. Based on the resources, the encryption library 345 provides a functionality to encrypt the data object 360 with a password or a key. In one embodiment, the encryption library 345 encrypts the data object 360 with the encryption key 340.

In one embodiment, the computer program 315 stores the encrypted data object 360 in distributed database record 355. The computer program 315 updates the distributed database record 355 to store the encrypted data object 360. The distributed database record 355 is associated with the computer system 310. The computer system 310 is connected to one or more computer systems in a peer-to-peer distributed network. For example, the computer system 310 may be part of the distributed network 100, FIG. 1. The computer system 310 is connected to the computer system 370 and to the computer system 385.

In one embodiment, the computer program 315 receives a request to read the data object 360. The request may be sent from the computer system 385. The computer system 385 may be associated with an application (not illustrated) that requests reading of the data object 360. For example, the application may receive input from a user of the application. It should be appreciated, however, that the application may be configured to automatically send reading requests to read one or more data objects from the computer program 315. For example, the requests to read the data objects may be sent automatically upon expiration of a deadline. The data objects may be extracted from the memory 350 of the computer program 315.

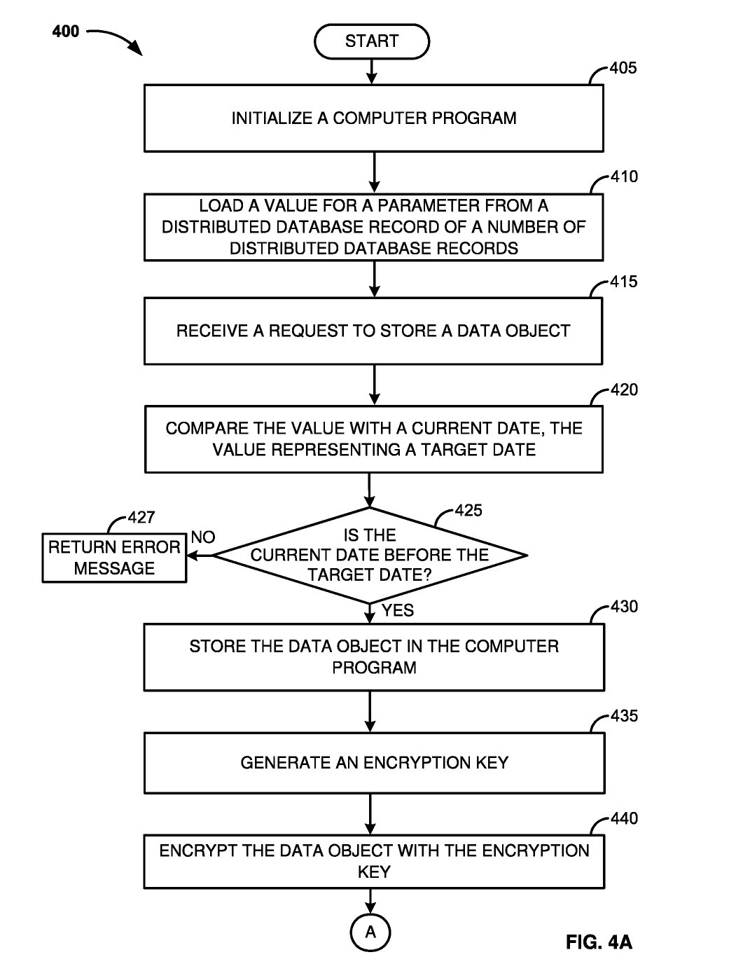

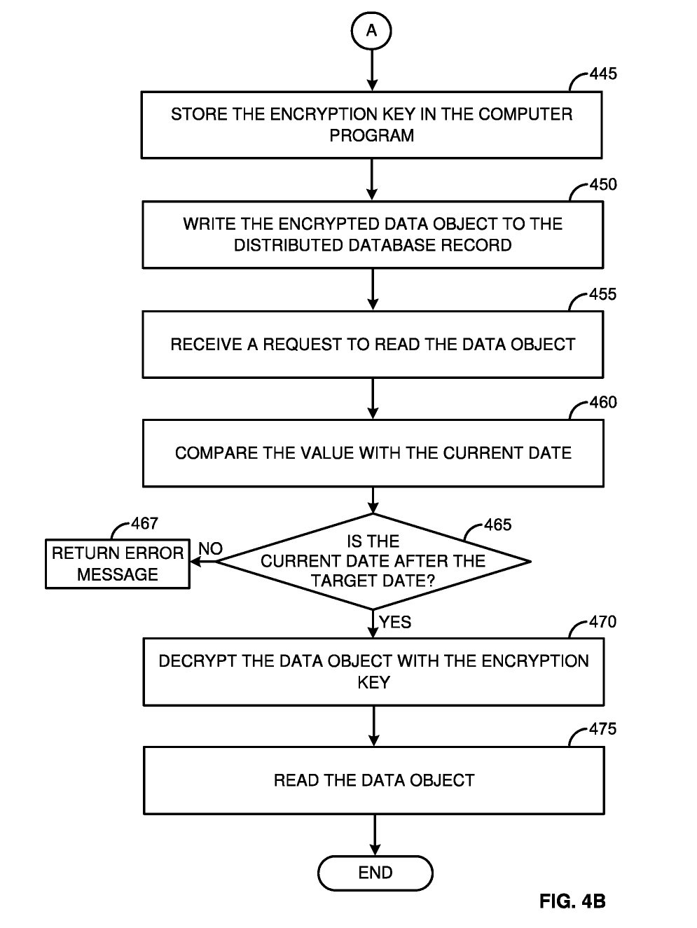

FIGS. 4A-4B illustrate process 400 to securely store data objects in a distributed database record, according to one embodiment. At 405 (FIG. 4A), a computer program is initialized. The computer program is a dedicated computer program for secure storage of data objects exchanged between computer systems within a distributed network. The computer program provides functionalities to store data objects and to read data objects. For example, the computer program may be similar to the computer program 315 that is initialized at the computer system 315, FIG. 3.

In one embodiment, the computer program is configured with a first condition for invoking a “write” function and a second condition for invoking a “read” function. The conditions are based on a value of a parameter of the computer program. At 410, the value of the parameter is loaded. The value may be loaded from a distributed database record such as the distributed database record 355, FIG. 3. It should be appreciated, however, that the value for the parameter may be loaded from various data sources capable of receiving and storing data. In one embodiment, the distributed database record is replicated to a number of computer systems in the distributed network. The distributed database record stores data written by the computer systems and metadata for the data. For example, distributed database record may store tracing and logging information for transactions executed over the stored data. In addition, the distributed database record may include a record of transactions executed by the computer systems within the distributed network. The computer systems within the distributed network maintain local copies of the distributed database record.

At 415, a request to store a data object is received at the computer program. For example, the “write” function of the computer program may be invoked when the request is received. The request includes the data object to be stored by the computer program. At 420, the value of the parameter is compared with a current date. For example, the evaluation module 320, FIG. 3 may evaluate the request and compare the current date with a target date that is specified by the value of the parameter. Upon the comparison, at 425, a check is performed to determine whether the current date is before the target date. In one embodiment, it is determined that the current date is not before the target date and, therefore, at 427, an error message is returned by the computer program.

When the current date is before the target date, it is determined that the first condition is fulfilled. At 430, the data object is stored in the computer program. At 435, an encryption key is generated within the computer program. For example, the encryption key may be generated by the key generator 335, FIG. 3. At 440, the data object is encrypted with the encryption key to prevent unauthorized access to information within the data object. Upon encryption, at 445 (FIG. 4B), the encryption key is stored by the computer program. For example, the encryption key may be stored in the memory 350, FIG. 3. When stored in the memory 350, the encryption key is available to the computer program while the computer program is running. The encryption key is not accessible to users of the computer program or to other computer programs. At 450, the encrypted data object is written to the distributed database record.

At 455, a request to invoke the “read” function is received at the computer program. At 460, the current date is compared with the value of the parameter. Upon comparison, at 465, a check is performed to determine whether the current date is after the target date. In one embodiment, it is determined that the current date is not after the target date and therefore, at 467, an error message is returned by the computer program.

When it is determined that the current date is after the target date and the second condition is fulfilled, at 470, the data object is decrypted with the encryption key. The data object may be decrypted by the computer program that stores the encryption key. Alternatively, when the computer program determines that the second condition is fulfilled, the computer program may provide the encryption key to an entity (e.g., a requesting entity) to decrypt the data object. At 475, the data object is read.

Described is a system that stores securely data objects in a distributed database record. The data objects are received at a computer system configured with a first condition, a second condition, and a parameter. The computer system writes data objects when the first condition is fulfilled and reads the data objects when the second condition is fulfilled. When the first condition is fulfilled, the computer system generates an encryption key for a data object and encrypts the data object with the encryption key. The encryption key is stored in a volatile-type memory of the computer system. The encryption key is stored in the volatile-type memory while the program is running. The encryption key is accessible to the computer program, but not accessible to users of the computer program or to other computer programs. The computer program writes the encrypted data object to a distributed database record. The distributed database record is replicated to a number of computer systems connected to the computer system in a peer-to-peer network. By storing the encrypted data object in the distributed database record, the computer system verifies that the data object is received in accordance with the first condition. This way, a transaction of storing the encrypted data object may be verified by the computer systems without sharing information included in the data object. The computer system authorizes reading of the data object when the second condition is fulfilled. Thus, the computer system eliminates fraud possibilities and ensures availability of the data objects at a later stage.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components may be implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java® programming language, C++, or other object-oriented programming language and development tools. Another embodiment may be implemented in hard-wired circuitry in place of, or in combination with machine readable software instructions.

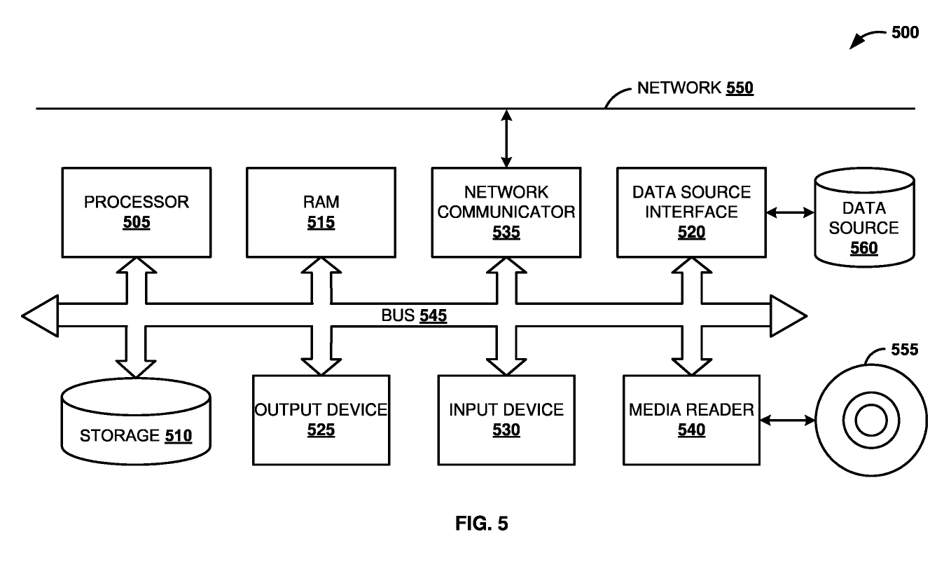

FIG. 5 is a block diagram of an exemplary computer system 500. The computer system 500 includes a processor 505 that executes software instructions or code stored on a computer readable storage medium 555 to perform the above-illustrated methods. The processor 505 can include a plurality of cores. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. According to some embodiments, such as some in-memory computing system embodiments, the RAM 515 can have sufficient storage capacity to store much of the data required for processing in the RAM 515 instead of in the storage 510. In some embodiments, all of the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments, the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in detail.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments of, and examples for, the one or more embodiments are described herein for illustrative purposes, various equivalent modifications are possible within the scope, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method, the method comprising:
initializing a computer program within a distributed network, wherein the computer program comprises one or more conditions for accessing data associated with the computer program;
loading one or more values for initializing one or more parameters within the one or more conditions based on data at a plurality of data blocks of a blockchain, wherein the plurality of data blocks is stored on a plurality of computer systems of the distributed network;
receiving, at the computer program, a first request associated with providing a data object to the distributed network in relation to a data block from one or more data blocks of the blockchain;
based on evaluating the first request according to the one or more conditions, storing the data object at the computer program; and
upon receiving a second request at the computer program to retrieve the data object, rejecting the second request when a retrieving condition from the one or more conditions is not fulfilled.

2. The method of claim 1, wherein storing the data object further comprises:
determining that a storing condition of the one or more conditions is fulfilled.

3. The method of claim 1, wherein storing the data object further comprises:
calculating a hash value based on the data object; and
writing the hash value to the data block.

4. The method of claim 1, further comprising:
generating a key for encrypting data objects to be provided to the distributed network; and
storing the key at the computer program.

5. The method of claim 4, further comprising:
encrypting the data object with the key; and
writing the data object to the data block.

6. The method of claim 5, further comprising:
replicating the data block to the plurality of data blocks.

7. The method of claim 5, further comprising:
receiving, at the computer program, the second request to retrieve the data object;
evaluating the second request according to the retrieval condition;
determining that the retrieval condition is fulfilled;
decrypting the data object with the key; and
reading the data object.

8. A computer system to securely store data objects, the system comprising:
a processor; and
a memory in association with the processor storing instructions related to:
initializing a computer program within a distributed network, wherein the computer program comprises one or more conditions for accessing data associated with the computer program;
loading one or more values for initializing one or more parameters within the one or more conditions based on data at a plurality of data blocks of a blockchain, wherein the plurality of data blocks is stored on a plurality of computer systems of the distributed network;
receiving, at the computer program, a first request associated with providing a data object to the distributed network in relation to a data block from one or more data blocks of the blockchain;
based on evaluating the first request according to the one or more conditions, storing the data object at the computer program; and
upon receiving a second request at the computer program to retrieve the data object, rejecting the second request when a retrieving condition from the one or more conditions associated with the data block is not fulfilled.

9. The computer system of claim 8, wherein storing the data object further comprises:
determining that a storing condition of the one or more conditions is fulfilled.

10. The computer system of claim 8, wherein storing the data object further comprises:
calculating a hash value based on the data object; and
writing the hash value to the data block.

11. The computer system of claim 8, wherein the instructions further comprising:
generating a key for encrypting data objects to be provided to the distributed network; and
storing the key at the computer program.

12. The computer system of claim 11, wherein the instructions further comprising:
encrypting the data object with the key; and
writing the data object to the data block.

13. The computer system of claim 12, wherein the instructions further comprising:
replicating the data block to the plurality of data blocks.

14. The computer system of claim 13, wherein the instructions further comprising:
receiving, at the computer program, the second request to retrieve the data object;
evaluating the second request according to the retrieval condition;
determining that the retrieval condition is fulfilled;
decrypting the data object with the key; and
reading the data object.

15. A non-transitory computer readable medium storing instructions which when executed by at least processor cause a computer system to perform operations comprising:
initialize a computer program within a distributed network, wherein the computer program comprises one or more conditions for accessing data associated with the computer program;
load one or more values for initializing one or more parameters within the one or more conditions based on data at a plurality of data blocks of a blockchain, wherein the plurality of data blocks is stored on a plurality of computer systems of the distributed network;
receive, at the computer program, a first request associated with providing a data object to the distributed network in relation to a data block from one or more data blocks of the blockchain;
based on evaluating the first request according to the one or more conditions, store the data object at the computer program; and
upon receiving a second request at the computer program to retrieve the data object, reject the second request when a retrieving condition from the one or more conditions associated with the data block is not fulfilled.

16. The computer readable medium of claim 15, wherein storing the data object further comprises:
determine that a storing condition of the one or more conditions is fulfilled.

17. The computer readable medium of claim 15, wherein storing the data object further comprises:
calculate a hash value based on the data object; and
write the hash value to the data block.

18. The computer readable medium of claim 15, wherein the operations further comprising:
generate a key for encrypting data objects to be provided to the distributed network; and
store the key at the computer program.

19. The computer readable medium of claim 18, wherein the operations further comprising:
encrypt the data object with the key; and
write the data object to the data block.

20. The computer readable medium of claim 19, wherein the operations further comprising:
receive, at the computer program, the second request to retrieve the data object;
evaluate the second request according to the retrieval condition;
determine that the retrieval condition is fulfilled;
decrypt the data object with the key; and
read the data object.
